(19) United States
(12) Patent Application Publication
(10) Pub. No.: US 2002/0131330 A1
(43) Pub. Date: Sep. 19, 2002

(54) Emergency information alert watch and method

(76) Inventors: Josef Zion, Plantation, FL (US); Menny Gila, Arlington, MA (US); Amir Ziv, Sunrise, FL (US)

Correspondence Address: COHEN SMITH & WHITE, 57 BEDFORD STREET, SUITE 103, LEXINGTON, MA, 02420, US

(21) Appl. No.: 09/808,531

(22) Filed: Mar. 14, 2001

(51) Int. Cl. G04C 19/00

(52) U.S. Cl. 368/82

(57) ABSTRACT

A emergency information watch contains, in addition to the normal watch functions, a mode whereby rescue information relating to the child elderly, or disabled person is stored for use by a rescuer when the child, elderly, or disabled person is lost. Information contained includes the child, elderly, or disabled person's name age address, telephone, names of parents or guardians, and alternative persons and phone numbers. Also contained in this data are ailments suffered by child, elderly, or disabled person, medications required, and other medical requirements. The rescue information is entered when the watch is placed in a special mode. Once entered, the rescue information is protected by a password, so that unauthorized persons cannot change the information without authorization. A rescuer will have his attention directed to the watch by dramatic rubric on the watch, indicating how to access the rescue information.

### BACKGROUND OF THE INVENTION

1. Field of the Invention

This invention relates to a watch wearable by a child, elderly, or disabled person which information usable to the finder of such person, such as parents' or guardian's phone numbers, cellular phone number, address, and/or other information.

2. Description of the Prior Art

A review of the field disclosed several references over which the invention is distinguishable. U.S. Pat. No. 5,157,640 Backner discloses an electronic watch which may be programmed by direct link to a pharmacist's computer to store a medication regime.

When a medication is to be taken an alarm on the watch is sounded and the medication and dosage are identified on the display of the watch. The watch is remotely programmed by the pharmacist's computer. No independent setting or operation or use of passwords is anticipated by Backner. U.S. Pat. No. 4,236,068 Walton discloses an emergency transmitter and personal identifier which can be periodically reprogrammed to protect against unauthorized use. A loudspeaker is integral to permit transmitting a signal through a telephone system. No particular limitation or implication to a readable face watch is indicated. No password system is involved.

U.S. Pat. No. 4,391,530 Wakabayashi, et al. (Casio) discloses a watch which can memorize voice data, which when a preset time is reached, the voice signal is coupled to a sound reproducing device. It basically operates as an alarm watch using changeable recorded music, rather than buzzing as the alarm output. No password system is involved.

References disclosing physical password entry and protection mechanisms, include U.S. Pat. No. 5,828,834 Choi, to input an ID code to a microprocessor, and U.S. Pat. No. 5,719,560 Watkins. None are involved with a watch context. References disclosing electronic modules holding information about a holder include U.S. Pat. No. 5,764,888 Bolan, etal.

A paging wristwatch is described in U.S. Pat. No. 5,479,37 Yamada, etal. (Seiko). U.S. Pat. No. 5,802,016 Kubota (Seiko) displays measured atmospheric pressure data in addition to normal time functions of an electronic watch. Also see U.S. Pat. No. 5,652,706 Lopkofker discloses a watch which receives medical and other information selected by and inputted directly from the individual. No password functions are included. One of the few references dealing with wristwatches for children include U.S. Pat. No. 5,652,569 Gerstenberger, etal., and which is basically a receiver locator. No password-requirement feature is included. U.S. Pat. No. 5,483,595 Owen (Seiko) includes a password system for a paging device. No prior art is anticipating the invention is known.

### SUMMARY OF THE INVENTION

It is an object of the present invention to provide a means and device to rescue a lost child, elderly, or disabled. It is a specific object of the invention to provide this means in the form of a watch, which also contains rescue information allowing a rescuer to contact the parents or caretakers of the child, elderly, or disabled, administer proper care, etc.

In accordance with one aspect of the invention, the rescue watch includes means to display time, means to enter rescue information, password means to protect entered rescue information, and means to retrieve and display the rescue information. The display of time and the rescue information are displayed on the watch at the same time, so that the rescue information is obvious to the rescuer.

In accordance with a second aspect of the invention, the rescue information is stored by digital storage means, and is displayed by digital display means.

In accordance with a third aspect of the invention, the display of time includes a digital display.

In accordance with a fourth aspect of the invention, the display of time includes an analog display.

In accordance with a fifth aspect of the invention, the display of rescue information includes a plurality of LCD modules.

In accordance with a sixth aspect of the invention, the invention further includes means to output the rescue information as voice output.

In accordance with a seventh aspect of the invention, the voice output further includes a synthetic voice audio stream.

In accordance with a final aspect of the invention, the time is displayed separately from the rescue information as a separate mode, and the different modes are accessed by mode buttons located on the watch.

### BRIEF DESCRIPTION OF THE DRAWINGS

These, and further features of the invention, may be better understood with reference to the accompanying specification and drawings depicting the preferred embodiment, in which:

FIG. I shows a digital watch in accordance with the prior art, a model D5011 manufactured by ZHANGZHOU HONGYUAN WATCH INDUSTRY CO.,LTD.

FIG. 2 shows a hybrid digital/analog display watch in accordance with the prior art, a model D5002 manufactured by ZHANGZHOU HONGYUAN WATCH INDUSTRY CO.,LTD.

FIG. 3 is a watch in accordance with the present invention shown in normal time mode.

FIG. 4. is a watch in accordance with the present invention, in attention mode.

FIG. 5 is a watch in accordance with the present invention, in name display mode.

FIG. 6 is a watch of the present invention shown in password-entering mode.

FIG. 7 is a watch of the present invention, shown in name entry mode.

FIG. 8 is a watch of the present invention, in keyboard mode.

### DESCRIPTION OF THE PREFERRED EMBODIMENTS

The purpose of the emergency watch is to provide information which will enable the finder of a lost child, elderly, or disabled person wearing such a watch with information enabling the finder to locate the lost person's parents or guardians, and to otherwise care for the person while the parents or guardians are being located.

Because many people wear watches, features designed for the purpose of rescuing a lost person are easily incorporated into a watch. Thus a person wearing the watch will always have this information available. In the present invention the rescue features are made apparent on the face of the watch, so that a rescuer will be directed to the use of these features.

The emergency watch encompasses a digital face watch having suitable character locations to display Stored Character Information, as well as the ordinary time and date information supplied by a normal watch.. This Stored character information is displayed either sequentially, or by means of scrolling, or by a combination of the two.

The watch capable of storing and displaying this information requires digital memory storage, digital processing means, and means to enter digital information. Many modem watches have this capability, but the watch of the present invention is configured to used these elements for the purpose of the invention. In an alternative embodiment, the watch is a digital/analog hybrid, with the time being displayed by an analog display, such as rotating hands, as in the traditional watch, but with the character information displayed as a text string by digital display means. LCD display characters are commonly used in digital watches, and are well suited for use in the present invention.

The last of these functions, the Stored Character Information, provides the rescuer of the lost child, elderly, or disabled person with rescue information. The nature of this function requires that the parent, or other care giver, have the ability to enter this information, and to protect the information from change with unauthorized persons. This function must make it easy for the user to enter the data. And equally importantly, it must make the information available to another user, presumably the lost person's rescuer, without any training whatsoever. Thus when this mode is entered, the text displayed must contain instructions to the user which describe exactly what the user must do to retrieve all the information contained.

The usual digital watch button functions performed by any of the methods known in the art can be used to set the features of the watch. Referring now to FIG. 1, a prior art example of a digital buttons display watch is shown, the ZHANGZHOU HONGYUAN Model D5011. This model has mode buttons 2,4,6, and 8 which control MODE, SET, and ALARM, and ACCESSORY/LIGHT. Other watches, such as the CASIO DATABANK TELEMEMO digital watches have provisions to store telephone numbers. However, the TELEMEMO is difficult to use, and does not have a password protection feature, as does the present invention.

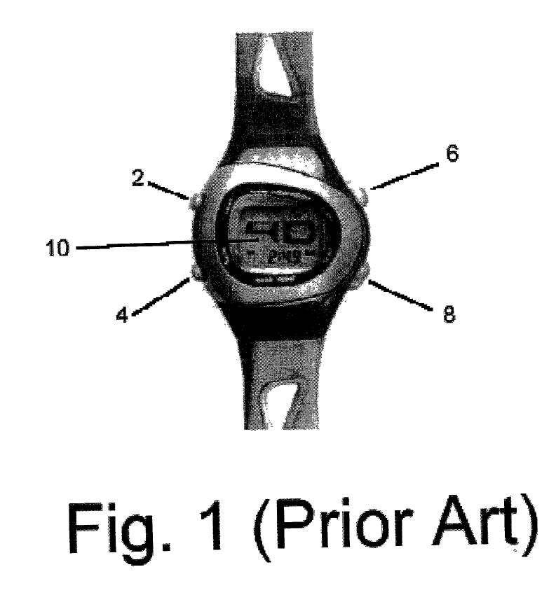

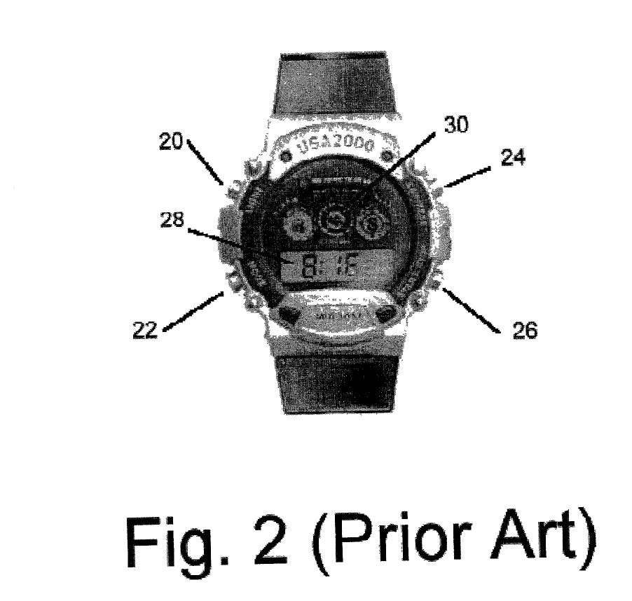

FIG. 2 shows a variation of the prior art watches having general character output capability. The watch shown, the ZHANGZHOU HONGYUAN model D5002, provides an analog display 30, as well as a digital display 28. The control buttons, 20, 22, 23, and 26, perform the same functions as in the digital watch just discussed.

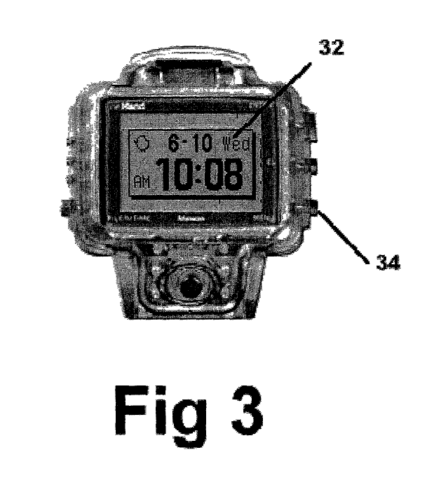

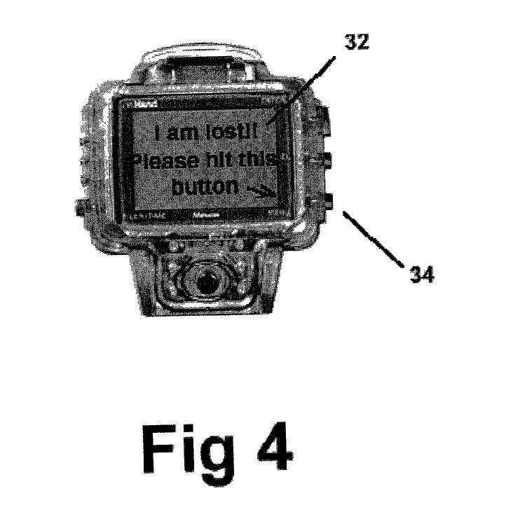

Referring now to FIG. 3, the preferred embodiment of the current invention has a normal digital display which shows time and date in the display area 32. By depressing mode control button 34, the display 32 switches to the ALARM mode, as shown in FIG. 4. In the case shown, the alarm alerts the rescuer to the fact that the person is lost, and also indicates that mode control button 34 should be depressed, as shown. The child, elderly, or disabled person should be informed to depress button 34 under these circumstances, and show the display to a potential rescuer.

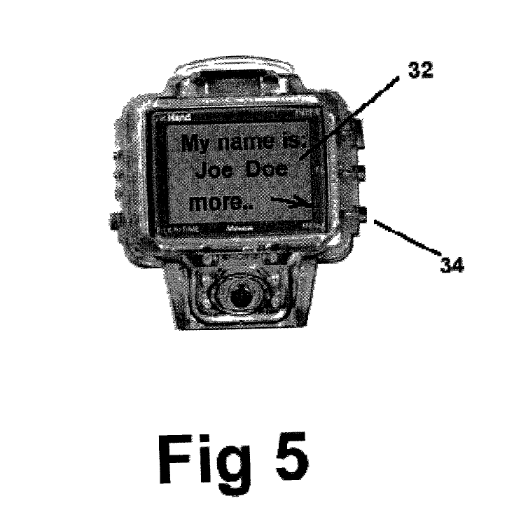

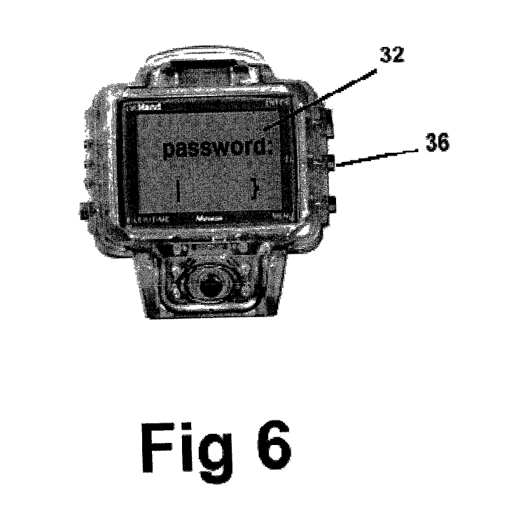

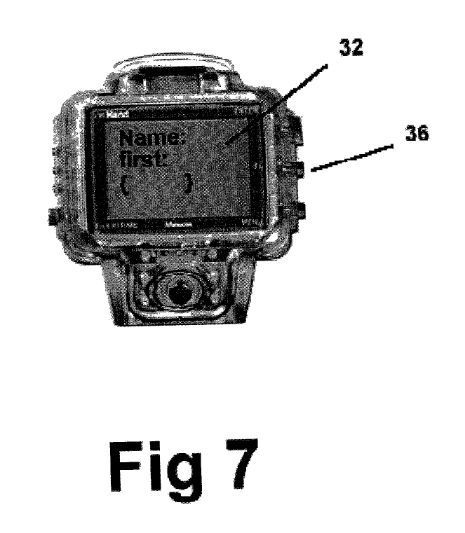

Once the mode control button 34 is depressed after the alarm display is shown, the first screen of information is shown, as depicted in FIG. 5, in which the person's name is give. The end of the screen shown in FIG. 5 also contains the prompt to remind the rescuer to continue to press button 34, until all the information contained is displayed. Continuing to press mode control button 34 will recycle the display indefinitely.

The watch of the preferred embodiment also contains provisions for entering or modifying the information contained therein. This is done by means of a second mode control button 36, which produces the PASSWORD display on the display area, requesting the user to enter a password before being allowed to either enter new data or to modify existing data. Once the password is entered, and mode control button 36 is depressed a second time, the display area 32 prompts the user for the various text strings used to identify the child, elderly, or disabled person, and provide other critical data. The data is entered within the brackets of the display, after which the user again depresses mode control button 36 to proceed to the next input string.

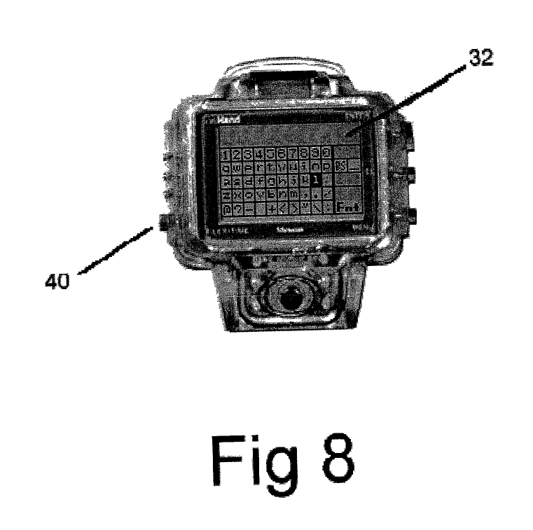

Data is entered by means of a virtual keyboard, as shown in FIG. 8. This virtual keyboard is accessed by depressing mode control key 40, which produces the keyboard. The user, using a stylus, ball point pen, or similar implement, taps the characters, one, at a time, and, when the character string has been entered, he depresses mode control key 36 to return to input mode, where the character string just entered will be displayed.

When any character string is already in existence and the user wishes to modify the contents, he taps the CLEAR key on the virtual keyboard, erasing the existing text string, and enters the desired information.

In the second preferred embodiment of the present invention, a single mode button is provided. Each time the mode button is pushed the display changes to the next information set. After the last information set is displayed, the watch repeats the first, etc. The information sets, in order, are as follows:

Normal time

Alarm Time

Chronograph

Countdown

Parentfinder/Password/DataEntry

For example, from Normal Time mode press and hold SET down for some minimum period of time to begin the setting procedure.

The SECONDS section of the display will begin flashing

Press START to advance seconds

Press MODE to set the correct hour. The Hour section of the display will begin flashing.

Press START to advance hours paying attention to the AM or PM indicator.

Press MODE to set the correct minutes. The Minutes section of the display will begin flashing.

Press START to advance minutes.

Press MODE to set the month. The month section of the display will begin flashing.

Press START to advance the month.

Press MODE to set the date. The date section of the display will begin flashing.

Press START to advance the date.

Press MODE to set the Day-of-Week section of the display. The Day-of-Week section of the display will begin flashing.

Press START to advance the Day-of-Week

Press MODE to select the 12 HR or 24 HR time. Press START to alternate between them.

Press MODE to enter the next mode

This could be the Password entering mode

The next mode could be the entering first dataset mode

When all modes have been gone through or to exit the flow chart, press SET .

This example procedure is but one example of how it could be performed.

In any event, the watch of the invention may have a flow chart as follows or similar once the parentfinder/password/dataentry mode is reached.

A direct password mode button is a more expensive embodiment, but within the scope of the present invention.

In operation, the system is preset with a certain password, say 00000. Once the password entry mode is reached, the user pushes SET to enter the first character. Then he pushes START to advance through 0-9,A-Z,“.19,95 99,4′”. Then he pushes SET to enter that character and move to the next character position. In an alternative embodiment, a different button, such as the “LIGHT” button, is used to back up one position. Again for each position, START is depressed to advance through the character set, and once the desired character is found, SET is depressed to advance to the next character. Pushing it after completing the last password character will put a question on the screen: “Change Password?” Keying in SET to exit the password entry mode, or START to go to the first character position. Pushing START again advances through the character set for that first position, and similarly as described above.

Once the password has been entered successfully, the watch enters the data-entry mode. As an example of operation in this embodiment, push SET to enter the next (first) data word/set, say parents or guardians' phone number, then push START to advance through the character set\until the desired character is on the display. For ease of entry, the default character should be a blank. Then push SET to go to the next character position in the dataset.

Alternatively push LIGHT to go back one character position. The use of another button, for instance 12/24 could be used to go to the next dataset without going through the rest of the current dataset.

In any event, either by pushing SET until all datasets are gone through sequentially, character-by-character, or by use of a go to next dataset button, the dataentry mode is then exited.

Finally, in use by a rescuer, the FIND or GET INFO button on the face of the watch is pressed, and each time the button is pushed, the next dataset is displayed on the watch, either in full view or in a rolling scrolling mode, or in a scrolling mode controlled by pushing the LIGHT button, or another, with a legend on the FIND button. By repeatedly pushing of the FIND/GET INFO button the complete set of text strings can be retrieved, and the parents or guardians' phone number, cellular number, address, or other information can be accessed with little training or effort by the finder of the lost child, elderly, or disabled person.

In other alternative embodiments, the rescue information is recorded as voice messages, and stored using either analog or digital storage techniques. One technique for outputting voice messages is to store the information as a text string, as in the embodiments previously described, and use a voice synthesizer to turn the text strings into a voice message audio output

While the invention has been described with reference to specific made within the purview of the invention without departing from the scope of the invention defined in the appended claims.

We claim:

1. A rescue watch, comprising:
means to display time;
means to enter rescue information;
password means to protect entered rescue information; and
means to retrieve and display the rescue information the display of time and the rescue information being displayed on the watch at the same time.

2. The rescue watch of claim 1, wherein the rescue information is stored by digital storage means, and is displayed by digital display means.

3. The rescue watch of claim 2, wherein the display of time comprises a digital display.

4. The rescue watch of claim 2, wherein the display of time comprises an analog display.

5. The rescue watch of claims 3 or 4, wherein said display of rescue information comprises a plurality of LCD modules.

6. A rescue watch, comprising:
means to display time;
means to enter rescue information;
password means to protect entered rescue information;
means to output the rescue information as voice output.

7. The rescue watch of claim 1 wherein said voice output further comprises a synthetic voice audio stream.

8. A rescue watch, comprising:
means to display time;
means to enter rescue information;
password means to protect entered rescue information; and
means to retrieve and display the rescue information the display of time and the rescue information being displayed alternately under the control of means to change mode

9. The rescue watch of claim 8, wherein the rescue information is stored by digital storage means, and is displayed by digital display means.

10. The rescue watch of claim 9 wherein said display of time and the display of rescue information comprises a plurality of LCD modules.

11. The rescue watch of claim 10 wherein said display of rescue information is accessed by a scrolling mode.

12. The rescue watch of claim 11, wherein the means of changing mode comprises on or more buttons.

13. The rescue watch of claim 12, wherein the means of inputting rescue data fisher comprises one or more buttons.

14. The rescue watch of claim 13, wherein the means of inputting rescue data further comprises voice-recording means.

15. The rescue watch of claim 14, further comprising voice outputting of the rescue information.

16. A method of rescuing a lost child, elderly, or disabled person, comprising wearing by the child, elderly, or disabled person of a rescue watch;
entering rescue information into the watch;
protecting the rescue information by password means;
displaying the rescue information on the watch.

17. The method of claim 16, further comprising:
storing the rescue information is stored by digital storage means; and
displaying the rescue information by digital display means.

18. The method of claim 17, further comprising displaying time by means of a digital display.

19. The method of claim 17, further comprising displaying of time as an analog display.

20. The method of claims 18 or 19 wherein said display of rescue information comprises a plurality of LCD modules.

21. The method of claim 20, further comprising inputting data by means of buttons.

22. The method of claim 21, further comprising displaying the rescue information by means of mode changing.
